(19) United States
(12) Patent Application Publication
(10) Pub. No.: US 2011/0026376 A1
(43) Pub. Date: Feb. 3, 2011

(54) SPECTRUM SENSING NETWORK FOR COGNITIVE RADIOS

(76) Inventors: Gokhan Memik, Evanston, IL (US); Seda Ogrenci Memik, Evanston, IL (US); Bill Mangione-Smith, Kirkland, WA (US)

Correspondence Address: EVAN LAW GROUP LLC, 600 WEST JACKSON BLVD., SUITE 625, CHICAGO, IL, 60661, US

(21) Appl. No.: 12/512,018

(22) Filed: Jul. 29, 2009

(51) Int. Cl. H04B 1/20

(52) U.S. Cl. 369/6

(57) ABSTRACT

Cognitive radio devices, methods and systems are generally described. In some examples a communication system includes a cognitive device and a communications device. The cognitive device may include a cognitive receiver for processing a cognitive task, an antenna for receiving radio frequencies in communication with the receiver, and a communications port. The communications device may include a cognitive radio having a processor in communication with a cognitive receiver and a cognitive transmitter. The communications device may also include a portable power source in communication with the cognitive radio and an antenna for sending and receiving signals. A communications port can be arranged in communication with the communications device, where cognitive information can be communicated with the communications device.

### REFERENCE TO RELATED APPLICATIONS

This application is related to the following co-pending applications, application Ser. No. ______ (Attorney Docket No. LLV01-004-US) entitled “Location and Time Sensing Cognitive Radio Communication Systems” filed ______; application Ser. No. ______ (Attorney Docket No. KLV01-006-US) entitled “Reputation Values in A Spectrum Sensing Network” filed ______; application Ser. No. ______ entitled “Secure Cognitive Radio Transmissions” (Attorney Docket No. BCV01-007-US) filed ______; application Ser. No. ______ (Attorney Docket No. UHV01-008-US) entitled “Cognitive Radios For Secure Transmissions” filed ______; and application Ser. No. ______ (Attorney Docket No. FDV01-009-US) entitled “Spectrum Sensing Network For Cognitive Radios” filed ______.

### BACKGROUND

The electromagnetic radio spectrum is a natural resource, the use of which by transmitters and receivers is licensed by governments. In many bands, spectrum access may be a more significant problem than physical scarcity of spectrum, in large part due to legacy command-and-control regulation that limits the ability of potential spectrum users to obtain such access. Indeed, if portions of the radio spectrum were scanned, including in the revenue-rich urban areas, one would find that some frequency bands in the spectrum are largely unoccupied most of the time; some other frequency bands are only partially occupied; and the remaining frequency bands are heavily used.

The underutilization of the electromagnetic spectrum has led to the view that spectrum holes within the electromagnetic spectrum exist. As used herein, a spectrum hole exists when a band of frequencies assigned to a primary user is not being utilized by that user, at a particular time and specific geographic location. By making it possible for a secondary user to access the band of frequencies within a spectrum hole, utilization of the electromagnetic spectrum is improved.

A cognitive radio, inclusive of software-defined radio, has been proposed as a means to promote the efficient use of the electromagnetic spectrum by exploiting the existence of spectrum holes. Cognitive radios may be radios which are reconfigurable, through software, and which process cognitive tasks. For tasks of a cognitive kind, the cognitive radio looks to signal-processing and machine-learning procedures for their implementation. The cognitive process may start with the passive sensing of RF stimuli, called spectrum sensing. The following are just examples of cognitive tasks performed by a cognitive radio: (1) radio-scene analysis, which encompasses: (1)(a) estimating interference temperature of a radio environment; and (1)(b) detecting spectrum holes, through a process called spectrum sensing; (2) channel identification, which encompasses: (2)(a) estimation of channel-state information; and (2)(b) prediction of channel capacity for use by the transmitter; and (3) transmit-power control and dynamic spectrum management.

These three tasks, (1) radio-scene analysis, (2) channel identification and (3) transmit-power control and dynamic spectrum management, may form a cognitive cycle. Radio-scene analysis and channel identification may be carried out by a receiver of a cognitive radio, while transmit-power control and dynamic spectrum management may be carried out by a transmitter of a cognitive radio. The cognitive radio may be therefore divided into a cognitive module within the transmitter and a cognitive module within the receiver. The cognitive module within the transmitter may work in a harmonious manner with the cognitive modules within the receiver. In order to maintain this harmony between the transmitter and receiver at all times, a feedback channel connects the two. Through the feedback channel, the receiver is able to convey information on the performance of the forward link to the transmitter, and is therefore a feedback communication system.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 depicts a cognitive radio system;

FIG. 2 depicts a schematic representation of a communications system; and

FIG. 3 depicts a flowchart illustration of methods, apparatus (systems) and computer program products, all arranged in accordance with at least some embodiments of the present disclosure.

### DETAILED DESCRIPTION

The following description sets forth various examples along with specific details to provide a thorough understanding of claimed subject matter. However, it will be understood by those skilled in the art that claimed subject matter may be practiced without some or more of the specific details disclosed herein. Further, in some circumstances, well-known methods, procedures, systems, components and/or circuits have not been described in detail in order to avoid unnecessarily obscuring claimed subject matter. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

This disclosure is drawn, inter alia, to methods, apparatus, systems and computer program products related to cognitive devices. The present disclosure may make use of the discovery that by offloading some of the cognitive tasks performed by a cognitive radio within a portable communications device to a cognitive radio within a cognitive device, which may be coupled to a constant power source, the amount of power required to operate the portable communications device may be minimized.

As used herein, the phrase “cognitive task” may include one or more of (1) radio-scene analysis, (2) estimating interference temperature (a metric which quantifies sources of interference in a radio environment), (3) detecting spectrum holes, by spectrum sensing, (4) channel identification, (5) estimation of channel-state information, (6) prediction of channel capacity for use by the transmitter, (7) transmit-power control, and/or (8) dynamic spectrum management. As used herein, the phrase “cognitive device” may include any device which may carry out cognitive tasks, such as a cognitive radio, or a cognitive receiver. As used herein, the phrase “cognitive information” may include any information which may be used to assist in carrying out a cognitive task. As used herein, the phrase “cognitive instruction” may include any instruction which may help accomplish a cognitive task.

In some embodiments, a cognitive device may include a cognitive receiver for processing a cognitive task and a communications device including a cognitive radio with a processor arranged in communication with the cognitive receiver.

In some additional embodiments, a cognitive device may process cognitive tasks for a communications device having a cognitive radio. The cognitive device may include a cognitive receiver, an antenna, and/or a communications port. The cognitive receiver may be arranged to process a cognitive task and produce cognitive information upon processing the cognitive task. The antenna may be adapted to receive radio frequencies in communication with the cognitive receiver. The communications port may communicate with the communications device. The communications port may be configured to communicate the cognitive information to the communications device. The cognitive receiver may include a processor arranged in communication with memory.

In still additional example embodiments, methods for communicating in a communications system may include a cognitive device with a cognitive receiver for processing a cognitive task and a communications device with a cognitive radio having a processor in communication with the cognitive receiver.

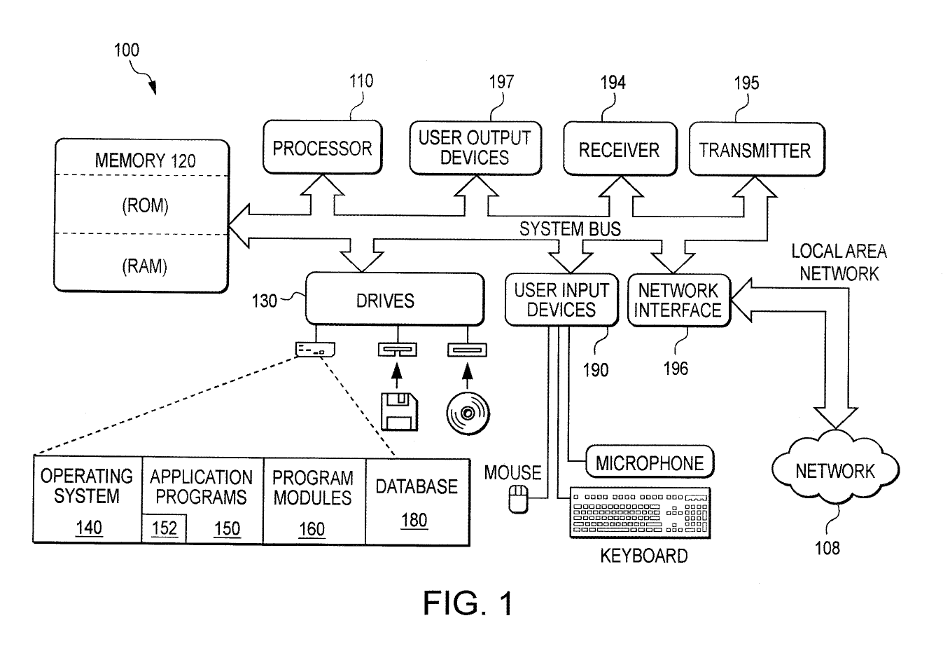

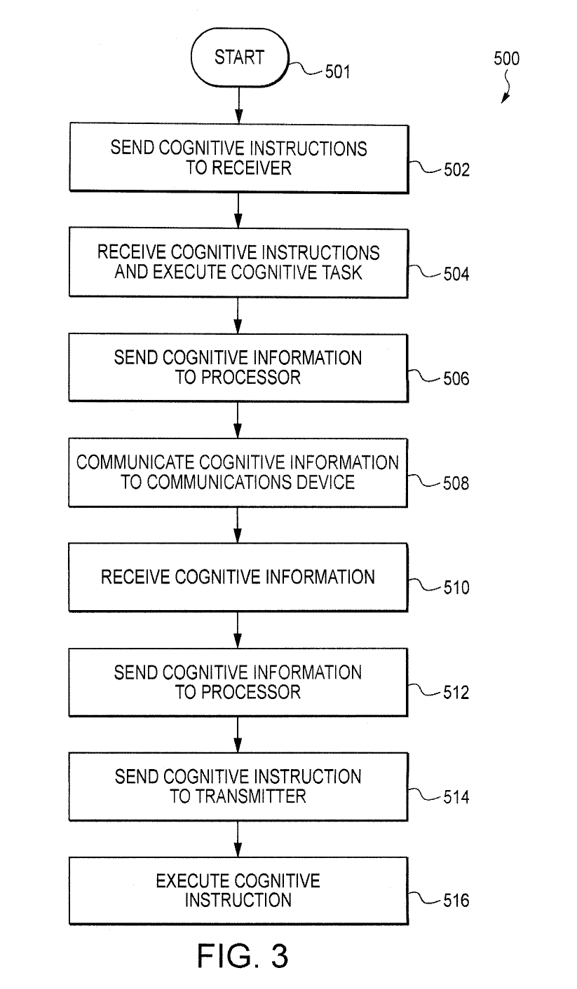

In FIG. 1 is depicted a cognitive radio system for implementing at least some embodiments in accordance with the present disclosure. FIG. 1 illustrates a cognitive radio 100, including a processor 110, a memory 120 and one or more drives 130. The drives 130 and their associated computer storage media, may be arranged to provide storage of computer readable instructions, data structures, program modules and other data for the cognitive radio 100. Drives 130 can include an operating system 140, application programs 150, program modules 160, and/or a database 180. Application programs 150, for example, may include an application program containing program instructions 152, for causing a cognitive radio 100 to carry out the functions specified in FIG. 3. Cognitive radio 100 may further include user input devices 190 through which a user may enter commands and data. Input devices can include an electronic digitizer, a microphone, a keyboard and a pointing device, commonly referred to as a mouse, trackball or touch pad. Other input devices may include a joystick, game pad, satellite dish, scanner, or the like.

These and other input devices can be coupled to processor 110 through a user input interface that may be coupled to a system bus, but may be connected by other interface and bus structures, such as a parallel port, game port or a universal serial bus (USB). Cognitive radio 100 may also include a receiver 194 through which radio frequency signals may be received and a transmitter 195 through which radio frequency signals may be transmitted. Cognitive radio 100 with receiver 194 and without transmitter 195 may be referred to herein as a cognitive receiver, and cognitive radio 100 with transmitter 195 and without receiver 194 may be referred to herein as a cognitive transmitter. In some embodiments, the cognitive radio 100 may include a transceiver, instead of receiver 194 and transmitter 195, wherein the transceiver operates as both a transmitter and a receiver.

Cognitive radio 100 may be configured to operate in a networking environment using connections to one or more computers, such as a remote computer coupled to network interface 196. The remote computer may be a personal computer (PC), a server, a router, a network PC, a peer device or other common network node, and can include some or all of the elements described above relative to cognitive radio 100. Networking environments are commonplace in offices, enterprise-wide area networks (WAN), local area networks (LAN), intranets and the Internet.

For example, cognitive radio 100 may be the source from which data is being migrated, and the remote computer may be the destination to which the data is being migrated, or vice versa. Note however, that the source and destination need not be connected by a network 108 or any other means, but instead data may be migrated via any media capable of being written by the source and read by the destination. When used in a LAN or WAN networking environment, cognitive radio 100 may be connected to the LAN through a network interface 196 or an adapter. When used in a WAN networking environment, cognitive radio 100 typically includes a modem or other means for establishing communications over the WAN, such as the Internet or network 108. It will be appreciated that other means of establishing a communications link between the source and destination may be used. Cognitive radio 100 may be also coupled to user output devices 197 for outputting information to a user. User output devices 197 may include a display, a printer and speakers.

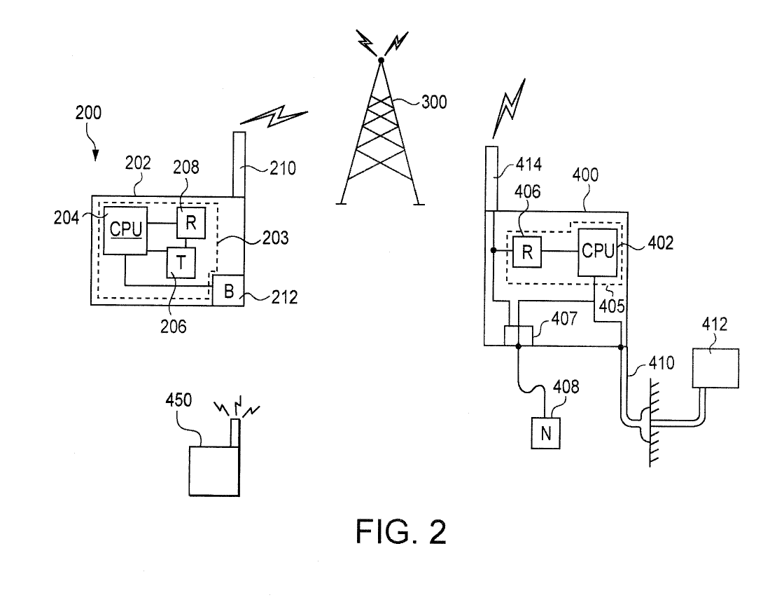

FIG. 2 depicts a schematic representation of a communications system, in accordance with at least some embodiments of the present disclosure. As shown in FIG. 2, a communications system 200 may be provided. The communications system 200 may include a communications device 202 that may be arranged in communication with a cognitive device 400 and a transmission tower 300 and another communications device 450.

The communications device 202 may be any device that may transmit or receive RF signals, and may be, for example, a wireless telephone, a radio, a hand-held two-way radio transceiver. The communications device 202 may include a cognitive radio 203, an antenna 210, and/or a power source 212. The cognitive radio 203 may be a wireless communication device that may be configured to adapt its transmission or reception parameters to communicate efficiently and avoid interference with licensed or unlicensed users of other communications devices 450. The cognitive radio 203 may be configured to perform cognitive tasks, which may include the alteration of parameters based on the active monitoring of several factors in the external and internal radio environment, such as radio frequency spectrum, user behavior and network state. The cognitive tasks performed by cognitive radio 203 may begin with the passive sensing of RF stimuli, called spectrum sensing. The following are examples of other optional cognitive tasks performed by cognitive radio 203: (1) radio-scene analysis, which may encompass: (1)(a) estimating interference temperature (a metric which quantifies sources of interference in a radio environment); and/or (1)(b) detecting spectrum holes, by spectrum sensing; (2) channel identification, which may encompass: (2)(a) estimation of channel-state information; and (2)(b) prediction of channel capacity for use by the transmitter; and/or (3) transmit-power control and dynamic spectrum management.

Cognitive radio 203 functionally may include all or some of the components of cognitive radio 100, as described herein. Cognitive radio 203 may include at least a processor 204 arranged in communication with a receiver 208 and optionally a transmitter 206. Transmitter 206 and receiver 208 may be replaced with a transceiver. Processor 204 may be arranged to send cognitive instructions to both the receiver 208 and transmitter 206 and may be arranged to receive cognitive information, such as spectrum sensing information, from the receiver 208 when performing and processing cognitive tasks, such as spectrum sensing tasks.

The spectrum-sensing task may be adapted to detect spectrum holes, which may be bands of unused radio frequencies in the radio frequency (RF) spectrum available for use by cognitive radio 203. The cognitive radio 203 and/or cognitive receiver 405 may be adapted to passively sense the RF spectrum and estimates the power spectra of incoming radio frequency stimuli, in order to classify the RF spectrum into one of three broadly defined types of radio frequencies: (1) black spaces, which are occupied by high-power “local” interferers some of the time; (2) grey spaces, which are partially occupied by low-power interferers; and (3) white spaces, which are free of RF interferers except for ambient noise, made up of natural and artificial forms of noise. Ambient noise may include: broadband thermal noise produced by external physical phenomena, such as solar radiation; transient reflections from lightening, plasma (fluorescent) lights, and aircraft; impulsive noise produced by ignitions, commutators, and microwave appliances; and thermal noise due to internal spontaneous fluctuations of electrons at the front end of individual receivers.

White spaces and grey spaces, to a lesser extent, may contain spectrum holes which make good candidates for use by cognitive radio 203. While black spaces are to be avoided when and where the RF emitters residing in them are switched ON, when those emitters are switched OFF, the black spaces assume a new role of “spectrum holes,” and the cognitive radio 203 and/or cognitive receiver 405 provide the opportunity for discovering significant “white spaces” within the unused black spaces.

As a result, by conducting a spectrum-sensing task, cognitive radio 203 may be able to determine which portion of the RF spectrum contains frequencies not being utilized, identifying spectrum holes. Thereafter, receiver 208 within cognitive radio 203 and/or cognitive receiver 405 may be arranged to communicate spectrum-sensing information which contains information regarding spectrum holes, to processor 204 within cognitive radio 203. The spectrum-sensing information may typically contain bands of frequencies within the white spaces and the grey spaces. Sometimes, however, the bands of frequencies may be within the black spaces. Cognitive radios may be described in: Haykin, S. “Cognitive Radio: Brain-Empowered Wireless Communications,” IEEE JOURNAL ON SELECTED AREAS IN COMMUNICATIONS, Vol. 23, No. 2, pp. 201-220 (February 2005).

In some embodiments, when performing a spectrum sensing task, the processor 204 may be adapted to send cognitive instructions to the receiver 208 instructing the receiver 208 to scan the RF spectrum for spectrum holes. The receiver 208 may be adapted to send spectrum sensing information to the processor 204 informing the processor 204 of spectrum holes (i.e., receiver 208 may inform the processor 204 which bands of RF frequencies may be available for use). The processor 204 may be arranged to send cognitive instructions to the transmitter 206 which may be arranged to transmit at a radio frequency available for use, or within one of the spectrum holes.

Receiver 208 may be adapted to receive RF signals, either digital or analog, from antenna 210 and transmitter 206 may be adapted to transmit RF signals through antenna 210. Antenna 210 may be configured to transmit or receive RF signals to transmission tower 300, which may broadcast these RF signals, for example, via land lines or other RF signals, to other communications devices, which may include wireless communications devices, such as communications device 450, or wired communications devices such as telephones. Antenna 210 may be adapted to send RF signals to and receive signals from other communications devices 450 and cognitive device 400.

Power source 212 may be arranged in communication with and may power cognitive radio 203. Power source 212 may be portable and may be, for example, a battery, a fuel cell, a lithium ion battery, and/or a capacitor.

Cognitive tasks, such as spectrum sensing, may require the detection of spectrum holes and their subsequent exploitation in the management of radio spectrum, which may be time consuming and may use significant power. By offloading some cognitive tasks from cognitive radio 203 to another device, such as cognitive device 400, the amount of electrical power used by communications device 202 may be reduced along with the amount of computational power. The amount of time required to perform cognitive tasks within the communications device 202 may also be reduced.

Cognitive device 400 may include a cognitive receiver 405 for processing cognitive tasks, an antenna 414 for receiving radio frequency signals, and a communications port 407. Cognitive device 400 may be in communication with communications device 202 through a variety of means, such as wired communication which may include USB, Firewire, and network cabling such as CAT-5 or fiber optic cable, or wireless communication which may include Bluetooth, Wi-Fi, WiMax, EDGE (Enhanced Data rates for GSM Evolution), GSM (Global System for Mobile communications), GPRS (General packet radio service), 3G, 4G, CDMA (Code division multiple access), or any other communications protocol which may transmit RF signals. In a LAN or WAN networking environment, cognitive device 400 may be arranged in communication with communications device 202 through a network interface 196 (FIG. 1) or an adapter. In a WAN networking environment, cognitive device 400 may include a modem or other means for establishing communications over the WAN, such as the Internet or network 108 (FIG. 1). Other means of establishing a communications link between the cognitive device 400 and the communications device 202 may also be used.

The cognitive receiver 405 may be a wireless communication device which may be configured to change its reception parameters to communicate efficiently and avoid interference with licensed or unlicensed users of other communications devices 450. The cognitive receiver 405 may be arranged to perform cognitive tasks, which may include the alteration of parameters based on the active monitoring of several factors in the external and internal radio environment, such as radio frequency spectrum, user behavior and network state. The cognitive tasks performed by cognitive receiver 405 may begin with the passive sensing of RF stimuli, called spectrum sensing, and an action may follow. The following examples of cognitive tasks may be performed by cognitive receiver 405: (1) radio-scene analysis, which may encompass: (1)(a) estimating interference temperature (a metric which quantifies sources of interference in a radio environment); and/or (1)(b) detecting spectrum holes, by spectrum sensing; (2) channel identification, which may encompass: (2)(a) estimation of channel-state information; and/or (2)(b) prediction of channel capacity for use by the transmitter.

Cognitive receiver 405 may include all the components of cognitive radio 100, as described herein. Cognitive receiver 405 may include at least a processor 402 that may be arranged in communication with a receiver 406. Processor 402 may be configured to send cognitive instructions to the receiver 406 and may be configured to receive cognitive information from the receiver 406 when performing and processing cognitive tasks, such as a spectrum sensing task.

In some examples, when performing a spectrum sensing task, the processor 402 may be adapted to send cognitive instructions to the receiver 406 instructing the receiver 406 to scan the RF spectrum for spectrum holes. The receiver 406 may adapted to send spectrum sensing information to the processor 402 informing the processor 402 of spectrum holes (i.e., receiver 406 may inform the processor 402 which bands of RF frequencies may be available for use). The process of sending spectrum sensing information to the processor 402 informing the processor 402 of spectrum holes may be repeated multiple times for different parts of the RF spectrum. The processor 402 may be arranged to send the cognitive information through the communications port 407 to the communications device 202, which may be arranged to receive the cognitive information through antenna 210 and forward the cognitive information to processor 204. Processor 204 may be arranged to instruct the transmitter 206 to transmit at a radio frequency that may be available for use, or within one of the spectrum holes. In this manner, cognitive receiver 405 may be able to perform certain cognitive tasks that would otherwise be performed by cognitive radio 203. In doing so, cognitive receiver 405 may be able to reduce the amount of electrical power and processing power used by cognitive radio 203. This may allow communications device 202 to be able to operate with a less powerful processor 204 and a lower capacity power source 212 or operate for longer durations.

Communications port 407 may be arranged in communication with the communications device 202 and may be arranged to communicate cognitive information to communications device 202. Communications port 407 may be configured in communication with the communications device 202 through a network 408. Communications port 407 may also be able to directly communicate with communications device 202 through antenna 414, and may be arranged to communicate cognitive information directly to communications device 202. Network 408 may be arranged in communication with both communications device 202 and cognitive device 400, for example, via a wired or wireless connection.

Receiver 406 may be configured to receive RF signals, either digital or analog, from antenna 414. Antenna 414 may be arranged to transmit or receive RF signals to/from transmission tower 300, which may broadcast these RF signals, for example, via land lines or other RF signals, to other communications devices, which may include wireless communications devices, such as communications devices 202 and 450, or wired communications devices such as telephones.

Cognitive device 400 may include a power source 410 which may be arranged in communication with and power cognitive receiver 405. Power source 410 may include a power connector that may be configured to connect with a stationary power source 412, such as a power generating plant. In this manner, cognitive device 400 may be able to use a nearly limitless supply of power in order to process cognitive tasks which may otherwise be processed by communications device 202.

FIG. 3 is flowchart illustrations of methods, which can be carried out by an apparatus or systems, for example under instructions from a computer program product, according to some embodiments of the present disclosure. It will be understood that each block of the flowchart illustrations in FIG. 3, and combinations of blocks in the flowchart illustrations in FIG. 3, can be implemented by computer program instructions. These computer program instructions may be loaded onto a computer or other programmable data processing apparatus to produce a machine, such that the instructions which execute on the computer or other programmable data processing apparatus are means for implementing the functions specified in the flowchart block or blocks. These computer program instructions may also be stored in a storage device that can direct a computer or other programmable data processing apparatus to function in a particular manner, such that the instructions stored in the storage device are an article of manufacture including instruction which implement the function specified in the flowchart block or blocks. The computer program instructions may also be loaded onto a computer or other programmable data processing apparatus to cause a series of operational steps to be performed on the computer or other programmable data processing apparatus to produce a computer implemented process such that the instructions which execute on the computer or other programmable apparatus implement the functions specified in the flowchart block or blocks.

Accordingly, blocks of the flowchart illustrations in FIG. 3 may support combinations of means for performing the specified functions, combinations of steps for performing the specified functions and program instruction means for performing the specified functions. It will also be understood that each block of the flowchart illustrations in FIG. 3, and combinations of blocks in the flowchart illustrations in FIG. 3, can be implemented by special purpose hardware-based computer systems, such as a cognitive radio, which may perform the specified functions, operations or steps, or combinations of special purpose hardware and computer instructions.

Such computer instructions may be fixed either on a tangible medium, such as a computer readable medium (for example, a diskette, CD-ROM, ROM, or fixed disk) or transmittable to a computer system, via a modem or other interface device, such as a communications adapter connected to a network over a medium. The medium may be either a tangible medium (for example, optical or analog communications lines) or a medium implemented with wireless techniques (for example, microwave, infrared or other transmission techniques). The series of computer instructions may embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (for example, shrink wrapped software), preloaded with a computer system (for example, on system ROM or fixed disk), or distributed from a server or electronic bulletin board over the network (for example, the Internet or World Wide Web).

FIG. 3 depicts a flowchart illustration of methods, apparatus (systems) and computer program products, in accordance with embodiments of the present disclosure. With reference to FIG. 3 example operations of cognitive device 400 in conjunction with communications device 202 will be described. A method 500 for processing a cognitive task for a communications device having a cognitive radio, such as communications device 202, may be initiated at block 501. Upon initiating the method 500 for processing a cognitive task at block 501, processor 402 may be configured to send cognitive instructions to the receiver 406 at block 502. The cognitive instructions may be any instruction that helps in accomplishing a cognitive task. At block 504, the receiver 406 may be adapted to receive the cognitive instructions and begin to execute a cognitive task, such as spectrum sensing, which may cause the receiver 406 to scan the RF spectrum for spectrum holes.

After initiating the cognitive task, the receiver 406 may be arranged to send cognitive information to the processor 402, at block 506. For example, the receiver 406 may send spectrum sensing information to the processor 402 informing the processor 402 of spectrum holes (i.e., the receiver may inform the processor 402 which bands of RF frequencies may be available for use). The processor 402 may be arranged to communicate the cognitive information to the communications device 202, at block 508. For example, the processor 402 may communicate spectrum sensing information to the communications device 202. The cognitive information may be communicated directly to the communications device 202 through antenna 414, or indirectly through a network 408 coupled to communications port 407.

At block 510, communications device 202 may be configured to receive the cognitive information from cognitive device 400. At block 512 the communications device 202 may be configured to send the cognitive information to processor 204. Processor 204 may be configured to send cognitive instructions to the transmitter 206 at block 514. The transmitter 206 may be arranged to execute the cognitive instructions at block 516. The cognitive instructions may include any instruction that helps in accomplishing a cognitive task. For example, the cognitive instructions sent by processor 204 to transmitter 206 may be adapted to instruct the transmitter 206 to transmit at a radio frequency that may be available for use, or within one of the spectrum holes.

The herein described subject matter sometimes illustrates different components contained within, or connected with, different other components. It is to be understood that such depicted architectures are merely examples and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various embodiments of the invention have been described, it will be apparent to those of ordinary skill in the art that other embodiments and implementations are possible within the scope of the invention. Accordingly, the invention is not to be restricted except in light of the attached claims and their equivalents.

1. A method of receiving information in a communications system, the method comprising:
receiving cognitive information with a cognitive radio from a cognitive device in a communications system; and
performing a cognitive task with the cognitive radio using the cognitive information.

2. The method of claim 1, further comprising collecting the cognitive information with the cognitive device.

3. The method of claim 1, wherein the cognitive device is powered by a stationary power source.

4. The method of claim 1, wherein the receiving is through a network.

5. The method of claim 1, wherein the cognitive information is channel identification information.

6. The method of claim 1, wherein the cognitive information is spectrum-sensing information.

7. A communications system, comprising:
a cognitive radio, comprising
a first processor,
a first receiver arranged in communication with the first processor, and
a first transmitter arranged in communication with the first processor, and
a cognitive receiver arranged in communication with the cognitive radio, the cognitive receiver comprising
a second processor, and
a second receiver arranged in communication with the second processor,
wherein the cognitive receiver is configured to collect cognitive information and communicate the cognitive information to the cognitive radio, and
the cognitive radio is configured to receive the cognitive information from the cognitive receiver.

8. The communications system of claim 7, wherein the cognitive receiver is powered by a stationary power source.

9. The communications system of claim 7, wherein the cognitive receiver communicates with the cognitive radio through a network.

10. The communications system of claim 9, wherein the network is the Internet or World Wide Web.

11. The communications system of claim 7, wherein the cognitive information is channel identification information.

12. The communications system of claim 7, wherein the cognitive information is spectrum-sensing information.

13. A method of transmitting information in the communications system of claim 7, comprising transmitting cognitive information from the cognitive receiver to the cognitive radio.

14. The method of claim 13, further comprising performing a cognitive task with the cognitive radio using the cognitive information.

15. The method of claim 13, further comprising collecting the cognitive information with the cognitive receiver.

16. The method of claim 13, wherein the cognitive receiver is powered by a stationary power source.

17. The method of claim 13, wherein the cognitive receiver communicates with the cognitive radio through a network.

18. A computer program product comprising software encoded in computer-readable media, for transmitting information, the software comprising instructions, operable when executed, to:
collect cognitive information with a cognitive device; and
transmit the cognitive information to a cognitive radio.

19. The computer program product of claim 19, wherein the cognitive information is channel identification information.

20. The computer program product of claim 19, wherein the cognitive information is spectrum sensing information.
